(19) United States
(12) Patent Application Publication
(10) Pub. No.: US 2008/0048992 A1
(43) Pub. Date: Feb. 28, 2008

(54) Electronic apparatus having display device

(75) Inventor: Kunio Sato, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/881,597

(22) Filed: Jul. 27, 2007

(30) Foreign Application Priority Data
Aug. 25, 2006 (JP) 2006-229275

(51) Int. Cl. G06F 3/041

(52) U.S. Cl. 345/173

(57) ABSTRACT

An electronic apparatus includes a display device having a case and a display unit provided on a top of the case so as to be viewable. An input device for inputting necessary operation information is provided such that the input device includes a recess defined on an edge part between a surface of the case and a side surface thereof. An electrostatic sensor is provided at a bottom surface side of the case corresponding to the edge part to detect operation of the input device.

### RELATED APPLICATIONS

This application claims the benefit of priority under 35 U.S.C. § 119 to Japanese Patent Application No. 2006-229275 filed on Aug. 25, 2006, which is hereby incorporated by reference in its entirety.

### BACKGROUND

1. Field of the Disclosure

The present disclosure relates to an electronic apparatus having a display device such as a liquid crystal display, and more particularly, an electronic apparatus having a display device configured such that a display as large as possible can be mounted in a small-sized main apparatus body.

2. Description of the Related Art

JP-A-7-192574 discloses a membrane touch-panel device. The touch panel device includes a panel surface, which is provided on the top surface of a main apparatus body and on which a display device, such as an LED or a liquid crystal panel, is detachably mounted, and a plurality of press keys provided around the panel surface.

The press keys are provided to be uneven with respect to the top surface of the touch panel device. Accordingly, an operator may search the position of a press key on the basis of the unevenness or perceive an operation only with the sense of a finger.

However, in the touch panel device disclosed in JP-A-7-192574, the press keys are disposed around a display device. For this reason, it is difficult to adopt a display device having a large screen size in the touch panel device.

That is, since the size of a main apparatus body (case) is limited, the screen size becomes smaller than the size of the case in order to secure a space for disposing the pressure keys.

In addition, in order to make the screen size of the display device large, one may consider applying a configuration having only a touch panel by eliminating the press keys. However, since a surface of the touch panel is generally flat, it is difficult to determine an operation or the position of a key only with the sense of a finger.

### SUMMARY

The disclosure has been finalized to solve the above-mentioned problems in the related art, and it is an object of the disclosure to provide an electronic apparatus having a display device, in which a display unit as large as possible can be mounted, even in a case when an input device is provided on a top surface of a case.

In addition, it is another object of the disclosure to provide an electronic apparatus having a display device that allows the position of a finger to be perceived only with the sense at the time of an operation.

According to an aspect of the disclosure, there is provided an electronic apparatus having a display device including: the display device having a case and a display unit provided on a top of the case so as to be viewed; and an input device for inputting necessary operation information. The input device is formed with a recess, which is formed on an edge part between a surface of the case provided with the display device and a side surface thereof, and an electrostatic sensor provided at a bottom surface side of the case corresponding to the edge part.

In the disclosure, almost the entire region of the top of the case can be used as a display region where a display device is provided. Accordingly, it becomes possible to mount a display device having a screen, which is as large as possible, on a small apparatus.

In the electronic apparatus described above, preferably, the recess is formed to have a curved surface that is recessed corresponding to the shape of an operator's finger.

In this case, the operator's finger fits within the recess. As a result, it is also possible to improve the operability.

Further, in the electronic apparatus described above, a plurality of recesses may be provided on the edge part. In this way, it is possible to provide the plurality of recesses that form the input device (switching device). Accordingly, various kinds of operations can be performed.

Furthermore, in the electronic apparatus described above, the recess may be formed on at least one of an edge part extending in the X direction and an edge part extending in the Y direction perpendicular to the X direction.

That is, the recess may be provided on all edge parts or may be provided on any one of the edge parts.

For example, the electrostatic sensor may be formed by using electrodes that are disposed on a bottom surface of the case so as to be opposite to the recess. In this way, it is possible to detect whether the operator's finger approaches or withdraws as operation information.

In addition, the electrostatic sensor may be formed by using a coordinate input device having X and Y detection electrodes disposed to be perpendicular to each other. In this way, it is possible to detect operation information corresponding to the position of the operator's finger or a clicking operation.

In the disclosure, it is possible to enlarge a display region where a display device is to be mounted. That is, since almost the entire top surface of the case can be used as a display region even in the case in which an input device is provided, it is possible to make the screen size of a display unit large.

Furthermore, since it is possible to perceive the current position of a finger with only the sense at the time of an operation, the operability can be improved.

### BRIEF DESCRIPTION OF THE DRAWINGS

FIG. 1 is a perspective view illustrating an electronic apparatus according to an embodiment of the disclosure;

FIG. 2 is a longitudinal sectional view illustrating an edge part taken along the line 2-2 of FIG. 1;

FIG. 3 is a cross-sectional view illustrating an edge part;

FIG. 4 is a cross-sectional view illustrating an electrostatic sensor according to another embodiment of the disclosure, which is similar to FIG. 3; and

FIG. 5 is a longitudinal sectional view illustrating a recess according to another embodiment of the disclosure, which is similar to FIG. 2.

### DETAILED DESCRIPTION

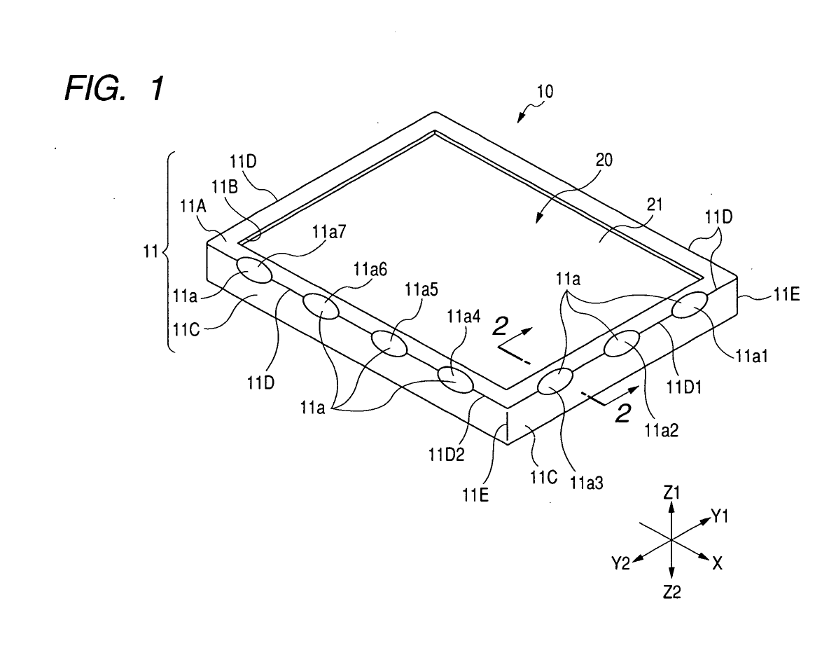

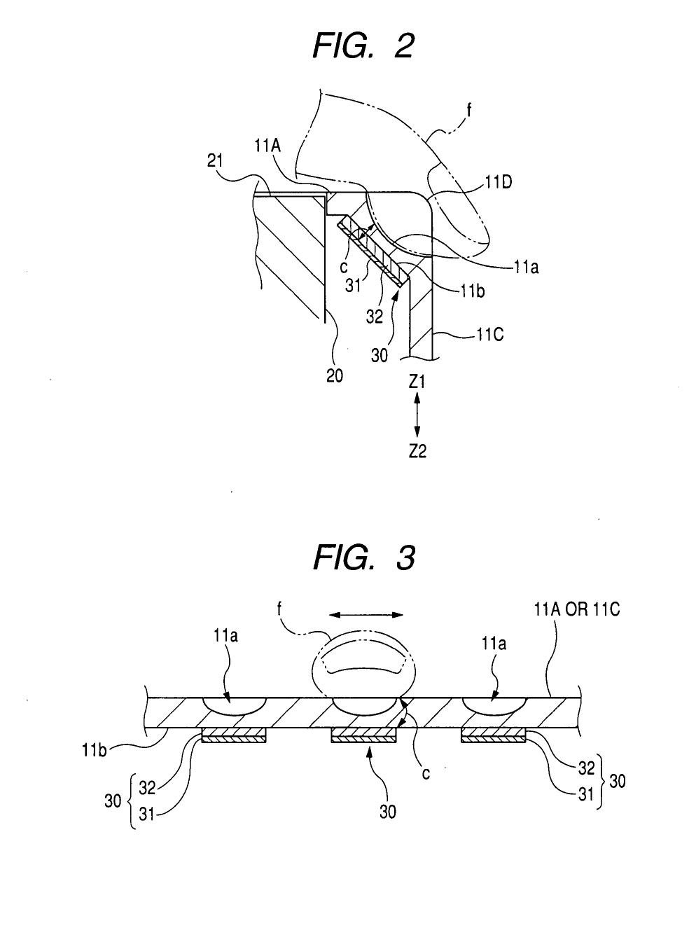

FIG. 1 is a perspective view illustrating an electronic apparatus according to an embodiment of the disclosure. FIG. 2 is a longitudinal sectional view illustrating an edge part taken along the line 2-2 of FIG. 1. FIG. 3 is a cross-sectional view illustrating an edge part.

An electronic apparatus 10 shown in FIG. 1 is a portable digital audio player, for example. However, the electronic apparatus is not limited to the digital audio player. For example, it is possible to use other electronic apparatuses, such as a portable phone, a digital camera, or a personal digital assistant (PDA).

The electronic apparatus 10 has a box-shaped case (housing) 11. The case 11 is formed by injection-molding a synthetic resin, such as plastic. On a top surface 11A of the case 11, an opening 11B that is largely opened in the rectangular shape is formed. A display device 20 is provided in the opening 11B.

The display device 20 is a liquid crystal display (LCD), an organic electroluminescence (EL) display, or the like. In addition, the display device 20 is mounted in a state in which a display screen 21 for performing screen display is positioned upward in the Z1 direction shown in FIG. 1. That is, the display screen 21 is positioned so that it can be viewed from the above. Furthermore, within the case 11 may be provided, inter alia, a recording unit such as a hard disk or a semiconductor memory, an audio signal output unit, a control unit, an input device, a power supply, and the like, (none shown) as well as the display device 20.

On the display screen 21 of the display device 20, various kinds of information, such as text information including an artist name, an album title, and a song title, image information on a still image or a motion picture, and the like may be displayed.

As shown in FIG. 1, an edge part 11D extending in the X and Y directions is formed at a boundary between the top surface 11A and a side surface 11c of the case 11. In addition, in a plurality of places of the edge part 11D, recesses 11a are formed to be located in a line. That is, in one edge part 11D1 extending in the shown Y direction, a plurality of recesses (shown as 11a1, 11a2, and 11a3, respectively) are disposed in a line spaced apart at predetermined distances. Similarly, in another edge part 11D2 extending in the X direction, a plurality of recesses (shown as 11a4, 11a5, 11a6, and 11a7, respectively) are disposed in a line spaced apart at predetermined distances. In addition, the edge part 11D may have a chamfered configuration as shown in FIG. 2.

Each recess 11a is recessed at a surface curved in the inner direction of the case 11 from a top surface of the edge part 11D. In addition, a radius of curvature of the recess is preferably set to be equal to or approximate an average radius of curvature of a tip of an operator's finger f. In such a manner, it becomes easy to fit the finger f in each recess 11a. As a result, it is possible to improve the operability. That is, by allowing each recess 11a to have the shape described above, a tip of the finger f is sequentially engaged with the recesses 11a1, 11a2, . . . , and 11a7 when the finger f placed on the edge part 11D slides along the X direction or the Y direction in which the edge part 11D extends. Thus, an operator may perceive the current position of the finger f on the basis of only the sense of the finger f. For example, when sliding the finger f on the edge part 11D1 in the direction from the shown Y1 side to the Y2 side, the finger f is first engaged with the recess 11a1, then engaged with the recess 11a2, and finally engaged with the recess 11a3. Thus, the operator may check the engagement situation (number of recess or angle of curved finger) by tactile feel in order to sense the current finger position.

In the embodiment shown in FIG. 2, a flat surface 11b extending in the X direction or the Y direction is formed on a back surface of the case 11 and a bottom portion opposite the edge part 11D. In addition, an electrostatic sensor 30 serving as an input device is fixed on the flat surface 11b so as to be opposite to recess 11a.

As shown in FIG. 2, the electrostatic sensor 30 has a laminated structure, in which dielectric 32 is laminated on a planar electrode 31, and is fixed on the flat surface 11b in a state in which the dielectric 32 is positioned toward the inside of the case 11. Moreover, if the case 11 is formed of a material having a dielectric constant, it is possible to adopt the configuration in which the dielectric 32 is not provided, that is, the configuration in which only the electrode 31 is provided.

As shown in FIG. 3, the electrostatic sensor 30 is provided at the position corresponding to a bottom of each recess 11a. In each electrostatic sensor 30, the electrode 31 forms an electrode at one side (power supply side) of a parallel plate type capacitor and the finger f of an operator forms the other electrode (at the ground side).

In the case 11 there is provided a detection circuit (not shown) that applies a predetermined pulse voltage to the one electrode (at the power supply side) (not shown) through a fixed resistor r (not shown) and detects the change of a voltage of the one electrode (at the power supply side).

When the finger f approaches or comes in contact with any one of the recesses 11a, electrostatic capacitance c of a capacitor formed between the electrode 31 and the finger f changes. Then, a value of an RC time constant (product of the resistor r and the electrostatic capacitance c) of the detection circuit changes. Accordingly, by monitoring rise time of an output of the pulse voltage during a predetermined period, the detection circuit can detect whether the finger f of the operator approaches or withdraws on the basis of a delayed degree of the rise time. In addition, by performing the monitoring for the plurality of recesses 11a in a predetermined period whenever necessary, it is possible to detect to which recess 11a the operator's finger f currently corresponds. That is, it is possible to detect operation information on which recess 11a is operated.

Therefore, it is possible to use the recess 11a as an input device (switching device) for inputting required operation information by assigning an executed function to each recess 11a. From this point of view, the recesses 11a, the electrostatic sensor 30, and the detection circuit (not shown) form an input mechanism for inputting operation information.

For example, it is possible to assign a function of a play button to the recess 11a1, a function of a stop button to the recess 11a2, and a function of a fast forward button to the recess 11a3. In addition, when the finger f of an operator has operated any one of the recess 11a1, the recess 11a2, and the recess 11a3, it is possible to detect that any one of the play button, the stop button, and the fast forward button have been selected on the basis of input of operation information, and then to execute various kinds of operations corresponding to a result of the detection.

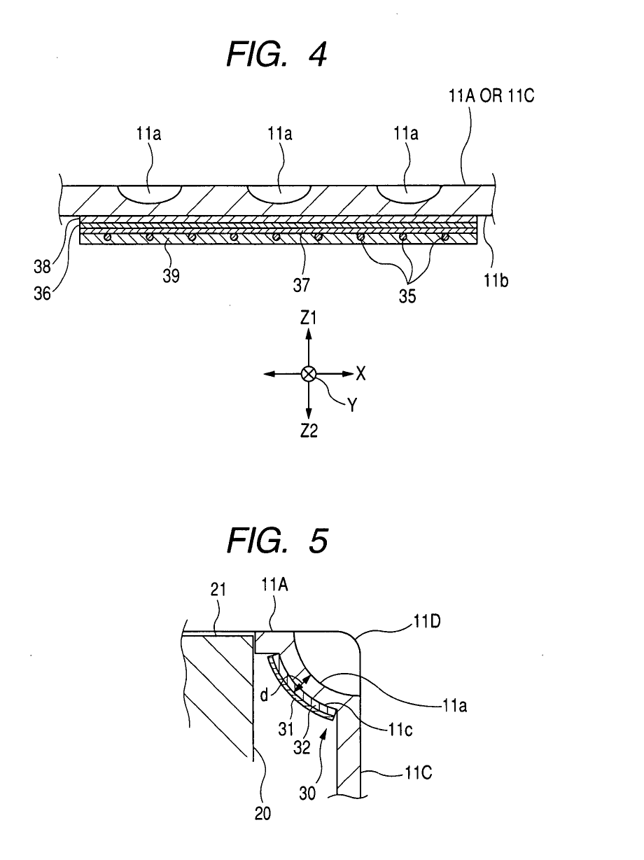

FIG. 4 is a cross-sectional view illustrating an electrostatic sensor according to another embodiment of the disclosure, which is similar to FIG. 3. FIG. 5 is a longitudinal sectional view illustrating a recess according to another embodiment of the disclosure, which is similar to FIG. 2.

In the embodiment shown in FIG. 4, a coordinate input device (or the electrostatic sensor 30 as displayed in FIG. 5), includes X detection electrodes 35 and Y detection electrodes 36 are disposed to be opposite to and cross each other in a three-dimensional manner with an insulating layer 37 interposed therebetween. In this case, the X detection electrodes 35 are formed by arranging a plurality of thin line shaped electrodes, which extend in the Y direction, but oriented in parallel to the X direction and spaced apart at predetermined distances therebetween. In addition, Y detection electrodes 36 are formed by arranging a plurality of thin line shaped electrodes, which extend in the X direction, but oriented in parallel to the Y direction spaced apart at predetermined distances therebetween. In addition, of the X detection electrodes 35 or the Y detection electrodes 36, the number of electrodes extending in the longitudinal direction along with the edge part 11D may be one.

Upper surfaces of the X detection electrodes 35 and the lower surfaces of the Y detection electrodes 36 are covered by other insulating layers 38 and 39, respectively. Moreover, in the electrostatic sensor 30, the upper insulating layer 38 is fixed on the flat surface 11b through an adhesion layer.

In this embodiment, when the finger f is placed on the edge part 11D, the electrostatic capacitance c between any one of the X detection electrodes 35 and any one of the Y detection electrodes 36 changes according to the position of the finger f. At this time, the detection circuit (not shown) detects the change of the electrostatic capacitance c as change of a voltage, and accordingly, the position of the finger f may be detected.

Thus, for example, when the finger f is placed on any recess 11a, it may be possible to detect that the recess 11a has been operated. However, in the case of determining that the recess 11a has been operated since the finger f is just placed on the recess 11a, there is a high probability of incorrect determination. For this reason, for example, it is detected that the recess 11a has been operated if a period of time for which the finger f faces the predetermined recess 11a. Alternatively, it is detected that the recess 11a has been operated if a clicking operation (operation of instantaneously withdrawing the finger f from the recess 11a and then bringing the finger f in contact with the recess 11a again) or a double clicking operation (operation of quickly repeating a clicking operation twice) has been performed. In this manner, it is possible to correctly detect whether or not an operation on the predetermined recess 11a has been performed. That is, as described above, it is possible to use the recess 11a as an input device (switching device).

In the electronic apparatus 10 according to the embodiment of the disclosure, the recess 11a and the electrostatic sensor 30 that form the input device may be disposed at the edge part 11D, which are an end of the case 11, and a bottom thereof, respectively. Accordingly, it becomes possible to use most of the top surface 11A of the case 11 as a display region where only the display device 20 is disposed. That is, it is not necessary to secure a large region, in which an input device is provided, on the top surface 11A of the case 11, in contrast to the related art. As a result, the screen size of the display device 20 may be enlarged to almost reach the edge part 11D of the case 11. That is, since a region of the top surface 11A of the case 11 can be utilized up to almost reaching the edge part 11D, it is possible to mount the display device 20 having a larger screen size.

Furthermore, in the embodiment of the disclosure, an input device including the plurality of recesses 11a is disposed on the edge part 11D of the case 11. Accordingly, it is possible to easily check the position of each recess 11a only through tactile feel. In particular, even in a dark place, an operator may perceive the current position of the finger f and the position of the recess 11a corresponding to the finger f only with the sense of the finger f. As a result, it is possible to reduce occurrence of an erroneous operation with respect to the electronic apparatus 10. In addition, if the operator is familiar with a method of operating the electronic apparatus, the operator memorizes a function (details of an operation) of each recess 11a. Accordingly, it is possible to quickly perform an operation only through tactile feel.

In the above embodiment described above, the plurality of recesses 11a are provided on only the edge part 11D1 extending in the Y direction and the edge part 11D2 extending in the X direction among the four edge parts 11D provided at the upper side of the case 11. However, the disclosure is not limited to the configuration. For example, the plurality of recesses 11a may be provided on at least one or more edge parts 11D.

Moreover, if the electronic apparatus 10 with the case 11 has an external appearance extending in the Z direction perpendicular to both the X direction and the Y direction, the plurality of recesses 11a may be formed on an edge part 11E (FIG. 1) extending in the Z direction.

Furthermore, in the embodiment described above, the number of recesses 11a formed on one edge part 11D is three or four. However, the disclosure is not limited thereto. For example, the number of recesses 11a formed on one edge part 11D may be one, two, or five or more.

Furthermore, the shape of a bottom surface of the recess 11a is not limited to the flat surface 11b shown in FIG. 2. For example, as shown in FIG. 5, the bottom surface of the recess 11a may be formed as a curved surface 11c extending along the recess 11a. In this case, the electrostatic sensor 30 may be formed to be curved along the curved surface 11c. With such configuration, it is possible to make a distance d from the electrode 31 to a top of the curved surface 11c almost constant. Thus, it is possible to stabilize the value of the electrostatic capacitance c in each recess 11a and to acquire more stable detection voltage. As a result, the input device can operate stably.

1. An electronic apparatus having a display device, comprising:
the display device having a case and a display unit provided on a top of the case so as to be viewable; and
an input device for inputting necessary operation information,
wherein the input device includes a recess, which is defined on an edge part between a surface of the case provided with the display device and a side surface thereof, and an electrostatic sensor provided at a bottom surface side of the case corresponding to the edge part to detect operation of the input device.

2. The electronic apparatus having a display device according to claim 1,
wherein the recess is formed to have a curved surface that is recessed corresponding to the shape of an operator's finger.

3. The electronic apparatus having a display device according to claim 1,
wherein a plurality of recesses are provided on the edge part.

4. The electronic apparatus having a display device according to claim 1,
wherein the recess is formed on at least one of an edge part extending in the X direction and an edge part extending in the Y direction perpendicular to the X direction.

5. The electronic apparatus having a display device according to claim 1,
wherein the electrostatic sensor is formed by using electrodes that are disposed on a bottom surface of the case positioned opposite to the recess.

6. The electronic apparatus having a display device according to claim 1,
wherein the electrostatic sensor is formed by using a coordinate input device having X and Y detection electrodes disposed perpendicular to each other.
